(19) United States
(12) Patent Application Publication
(10) Pub. No.: US 2021/0108051 A1
(43) Pub. Date: Apr. 15, 2021

(54) RUBBER COMPOSITION FOR BLADDER

(71) Applicant: Toyo Tire Corporation, Itami-shi (JP)

(72) Inventor: Kaoru Horiuchi, Itami-shi (JP)

(73) Assignee: Toyo Tire Corporation, Itami-shi (JP)

(21) Appl. No.: 17/017,038

(22) Filed: Sep. 10, 2020

(30) Foreign Application Priority Data
Oct. 11, 2019 (JP) 2019-187815

(51) Int. Cl. C08L 19/00; B29D 30/06

(52) U.S. Cl. CPC C08L 19/006; B29K 2819/00; B29D 2030/0655; B29D 30/0654

(57) ABSTRACT

A rubber composition for bladder contains a rubber component containing butyl rubber, a fluorine-based polymer, and a citraconimide compound. When a total amount of the rubber component containing butyl rubber is taken as 100 parts by mass, the fluorine-based polymer is contained in an amount of 0.1 to 2 parts by mass and the citraconimide compound is contained in an amount of 0.2 to 2 parts by mass. It is preferable that the rubber composition for bladder further contains 1 to 10 parts by mass of a sorbitan fatty acid ester. It is preferable that the rubber composition for bladder further contains 1 to 10 parts by mass of a vegetable oil.

### BACKGROUND OF THE INVENTION

### Field of the Invention

The present invention relates to a rubber composition for bladder, and particularly relates to a rubber composition for bladder as a raw material of a highly durable bladder for use in tire vulcanization.

### Description of the Related Art

A pneumatic tire is generally produced through a vulcanization process. In the vulcanization process, an unvulcanized green tire is set in a mold whose temperature can be adjusted to a vulcanizing temperature, and a bladder placed inside the green tire is expanded so that the green tire is pressed against the mold to have a shape close to the inner surface shape of the mold.

The bladder used in the vulcanization process is repeatedly used for tire production, and therefore it is important to improve the durability of the bladder in consideration of tire productivity and costs. The bladder is generally constituted from a rubber member for its mechanism, and repeatedly comes into contact with a green tire and is exposed to an atmosphere at a vulcanizing temperature in the vulcanization process. Therefore, various measures need to be taken to improve the durability of the bladder.

Patent Document 1 listed below discloses a bladder for tire vulcanization having a tubular main body formed of a rubber composition. The rubber composition is mixed with 0.1 parts by weight or more and 15 parts by weight or less of a fluoroalkyl group-containing fluorine-based polymer per 100 parts by weight of the rubber composition so that fluoroalkyl groups are oriented on the outer surface side of the tubular main body to modify the entire outer surface of the tubular main body.

### PRIOR ART DOCUMENT

### Patent Document

Patent Document 1: JP-A-2015-217576

### SUMMARY OF THE INVENTION

However, as a result of intensive studies, the present inventor has found that the above-described technique disclosed in Patent Document 1 has room for improvement to further improve the durability of the bladder.

In view of the above circumstances, it is an object of the present invention to provide a rubber composition for bladder as a raw material of a highly durable bladder for use in tire vulcanization.

The above object can be achieved by the following structure. That is, the present invention relates to a rubber composition for bladder containing a rubber component containing butyl rubber, a fluorine-based polymer, and a citraconimide compound, wherein when a total amount of the rubber component containing butyl rubber is taken as 100 parts by mass, the fluorine-based polymer is contained in an amount of 0.1 to 2 parts by mass and the citraconimide compound is contained in an amount of 0.2 to 2 parts by mass.

The rubber composition for bladder according to the present invention contains a rubber component containing butyl rubber, a predetermined amount of a fluorine-based polymer, and a predetermined amount of a citraconimide compound. As can be seen from experimental results that will be described later, this not only improves the releasability of a bladder obtained after vulcanization but also significantly improves the durability of the bladder.

The rubber composition for bladder preferably further contains 1 to 10 parts by mass of a sorbitan fatty acid ester. The durabililty of a vulcanized rubber is further improved by further adding a predetermined amount of a sorbitan fatty acid ester in addition to the fluorine-based polymer and the citraconimide compound.

The rubber composition for bladder preferably further contains 1 to 10 parts by mass of a vegetable oil. The durabililty of a vulcanized rubber is further improved by further adding a predetermined amount of a vegetable oil in addition to the fluorine-based polymer and the citraconimide compound.

### DETAILED DESCRIPTION OF THE PREFERRED EMBODIMENT

A rubber composition for bladder according to the present invention contains a rubber component, a fluorine-based polymer, and a citraconimide compound.

The rubber composition for bladder according to the present invention contains at least butyl rubber as the rubber component. The butyl rubber may be butyl rubber obtained by copolymerizing isobutylene and isoprene at any given ratio or halogenated butyl rubber obtained by halogenating part of butyl rubber. Examples of the halogenated butyl rubber include brominated butyl rubber and chlorinated butyl rubber. The rubber composition for bladder according to the present invention may contain, as the rubber component, a diene-based rubber other than the butyl rubber, such as natural rubber, polyisoprene rubber, polybutadiene, polystyrene butadiene rubber, chloroprene rubber, or nitrile rubber. However, in consideration of the airtightness and heat resistance of a bladder obtained by subjecting the rubber composition for bladder to vulcanization and molding, a butyl rubber content is preferably 80 parts by mass or more, more preferably 90 parts by mass or more when the total amount of the rubber component is taken as 100 parts by mass.

Examples of the fluorine-based polymer include: one containing polyester, polyacrylate, or polyethylene as a main chain and having, as a side chain, fluorine atoms directly bound to the main chain; and one containing polyester, polyacrylate, or polyethylene as a main chain and having, as a side chain, alkyl groups some of which have been fluorinated. Among them, a fluorine-based resin is preferred which contains polyester as a main chain and has, as aside chain, alkyl groups at least some of which have been fluorinated. In consideration of the durability of a bladder obtained by subjecting the rubber composition for bladder to vulcanization and molding, the amount of the fluorine-based resin contained in the rubber composition for bladder is preferably 0.1 to 2 parts by mass, more preferably 0.3 to 1 part by mass when the total amount of the rubber component is taken as 100 parts by mass.

Examples of the citraconimide compound include compounds having at least a structural formula represented by the following formula:

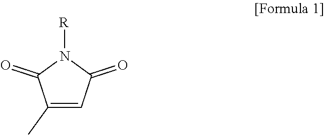

wherein R represents a substituted or unsubstituted aliphatic hydrocarbon group, aryl group, or heterocyclic group. Particularly, the citraconimide compound is preferably 1,3-bis(citraconimidemethyl)benzene represented by the following formula.

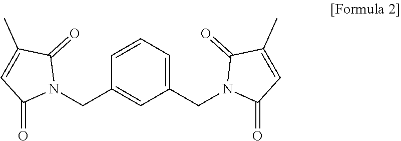 [SMILES: CC1=CC(=O)N(Cc2cccc(CN3C(=O)C=C(C)C3=O)c2)C1=O]

In consideration of the durability of a bladder obtained by subjecting the rubber composition for bladder to vulcanization and molding, the amount of the citraconimide compound contained in the rubber composition for bladder is preferably 0.2 to 2 parts by mass, more preferably 0.5 to 1 part by mass when the total amount of the rubber component is taken as 100 parts by mass.

A sorbitan fatty acid ester is an ester of sorbitan and a fatty acid, and examples thereof include sorbitan monolaurate, sorbitan monopalmitate, sorbitan monostearate, sorbitan tristearate, sorbitan monooleate, and sorbitan trioleate. Among them, sorbitan monostearate is preferably used. In consideration of the durability of a bladder obtained by subjecting the rubber composition for bladder to vulcanization and molding, the amount of the sorbitan fatty acid ester contained in the rubber composition for bladder is preferably 1 to 10 parts by mass, more preferably 2 to 8 parts by mass, particularly preferably 3 to 5 parts by mass when the total amount of the rubber component is taken as 100 parts by mass.

Examples of a vegetable oil include castor oil, rape oil, coconut oil, and soybean oil. Among them, castor oil is preferably used. In consideration of the durability of a bladder obtained by subjecting the rubber composition for bladder to vulcanization and molding, the amount of the vegetable oil contained in the rubber composition for bladder is preferably 1 to 10 parts by mass, more preferably 2 to 8 parts by mass, particularly preferably 3 to 5 parts by mass when the total amount of the rubber component is taken as 100 parts by mass.

The rubber composition for bladder according to the present invention may contain, as a component other than the rubber component, the fluorine-based polymer, the citraconimide compound, and the vegetable oil and the sorbitan fatty acid ester that are further optionally added, a compounding agent known to those skilled in the art, such as carbon black, silica, a silane coupling agent, a vulcanization-type compounding agent, an anti-aging agent, zinc oxide, stearic acid, a wax, a softener such as an oil, or a processing aid.

Examples of the carbon black that can be used include: carbon blacks usually used in the rubber industry, such as SAF, ISAF, HAF, FEF, and GPF; and conductive carbon blacks such as acetylene black and ketjen black. The amount of the carbon black contained in the rubber composition for bladder according to the present invention is preferably 10 to 120 parts by mass, more preferably 20 to 100 parts by mass per 100 parts by mass of the total amount of the rubber component.

Examples of the silica to be used include silicas usually used for rubber reinforcement, such as wet silica, dry silica, sol-gel silica, and surface-treated silica. Among them, wet silica is preferred.

The silane coupling agent is not particularly limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

Examples of the anti-aging agent include anti-aging agents usually used for rubbers, such as an aromatic amine-based anti-aging agent, an amine-ketone-based anti-aging agent, a monophenol-based anti-aging agent, a bisphenol-based anti-aging agent, a polyphenol-based anti-aging agent, a dithiocarbamic acid salt-based anti-aging agent, and a thiourea-based anti-aging agent. These anti-aging agents may be used singly or in combination of two or more of them.

Examples of the vulcanization-type compounding agent include a vulcanizing agent such as sulfur or an organic peroxide, a vulcanization accelerator, a vulcanization accelerator aid, and a vulcanization retarder.

The sulfur as the vulcanization-type compounding agent is not particularly limited as long as it is sulfur usually used for rubbers, and examples of such sulfur to be used include powdered sulfur, precipitated sulfur, insoluble sulfur, and highly-dispersible sulfur.

Examples of the vulcanization accelerator include vulcanization accelerators usually used for rubber vulcanization, such as a sulpheneamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator. These vulcanization accelerators may be used singly or in combination of two or more of them.

The rubber composition according to the present invention can be obtained by kneading the rubber component, the fluorine-based polymer, the citraconimide compound, the vegetable oil and the sorbitan fatty acid ester that are further optionally added, and further the compounding agent such as carbon black, silica, a silane coupling agent, a vulcanization-type compounding agent, an anti-aging agent, zinc oxide, stearic acid, a wax, a softener such as an oil, or a processing aid with the use of a kneader usually used in the rubber industry, such as a Banbury mixer, a kneader, or a roll.

A method for mixing the above components is not particularly limited, and any one of the following methods may be used: a method in which components to be added other than vulcanization-type compounding agents such as a sulfur-based vulcanizing agent and a vulcanization accelerator are previously kneaded to prepare a master batch, the remaining component is added to the master batch, and the mixture is further kneaded, a method in which components are added in any order and kneaded, and a method in which all the components are added at the same time and kneaded.

### Examples

Hereinbelow, the structure and the effect of the present invention will be described with reference to specific examples etc. It is to be noted that in examples etc., evaluation of evaluation items was performed according to the following criteria on rubber samples obtained by heating and vulcanizing rubber compositions at 180° C. for 30 minutes.

(1) Releasability from Vulcanized Rubber

Tires were continuously vulcanized without applying a liquid onto the inner surfaces of the tires to count the number of tires until peeling of inner surface of the tire occurred. When the number of tires until peeling of inner surface of the tire occurred was 5 or less, releasability was evaluated as x, and when the number of tires until peeling of inner surface of the tire occurred was 25 or more, releasability was evaluated as O. The symbol O indicates that releasability is excellent.

### (2) Bladder Durability (Bladder Life)

The number of times that the bladder was used for vulcanization was counted, and an index number was determined by taking the number of times that the bladder of Comparative Example 1 was used as 100 to evaluate bladder durability. A larger value indicates that bladder durability is more excellent.

### (Preparation of Rubber Compositions)

Rubber compositions of Examples 1 to 4 and Comparative Example 1 were prepared according to formulations shown in Table 1 and kneaded using a usual Banbury mixer. Compounding agents listed in Table 1 are shown below (in Table 1, the amount of each of the compounding agents added is expressed in parts by mass per 100 parts by mass of the rubber component).

a) Butyl rubber; trade name “Exxson butyl 268” (manufactured by ExxsonMobil)
b) Fluorine-based polymer (perfluoroalkylpolyester); trade name “DAIFREE FB-961” (manufactured by DAIKIN INDUSTRIES, LTD)
c) Citraconimide compound; trade name “Perkalink 900-PST” (manufactured by LANXESS)
d) Carbon black

Acetylene black; trade name “DENKA BLACK” (manufactured by Denka Company Limited)

ISAF; trade name “Showa Black N220” (Cabot Japan)

e) Sorbitan fatty acid ester (sorbitan monostearate); trade name “RHEODOL SP-S10V” “manufactured by Kao Corporation)
f) Vegetable oil (castor oil); trade name “Castor oil (Kaku A)” (manufactured by Itoh Oil Chemicals Co., Ltd.)
g) Resin master batch for cross-linking (component ratio: “resin”/“zinc oxide”/“butyl rubber”=40/25/35); trade name “Rhenogran GE3047T” (manufactured by LANXESS)

TABLE 1

| | | | | |
|---|---|---|---|---|
| Comparative | | | | |
| Example 1 | Example 1 | Example 2 | Example 3 | Example 4 |

(Formulation)

| | | | | | |
|---|---|---|---|---|---|
| Butyl rubber | 100 | 100 | 100 | 100 | 100 |
| Citraconimide compound | 1 | 1 | 1 | 1 | 1 |
| Carbon black (acetylene black) | 30 | 30 | 30 | 30 | 30 |
| Carbon black (ISAF) | 30 | 30 | 30 | 30 | 30 |
| Sorbitan fatty acid ester | 5 | 5 | 5 | 5 | 5 |
| Vegetable oil | 5 | 5 | 5 | 5 | 5 |
| Resin master batch for | 20 | 20 | 20 | 20 | 20 |
| cross-linking | | | | | |
| Fluorine-based resin | 0 | 0.35 | 0.5 | 1 | 2 |

(Physical properties)

| | | | | | |
|---|---|---|---|---|---|
| Releasability | x | ∘ | ∘ | ∘ | ∘ |
| Bladder life | 100 | 110 | 115 | 130 | 160 |

As can be seen from the results shown in Table 1, the vulcanized rubbers of the rubber compositions according to Examples 1 to 4 are superior in releasability and bladder durability to the vulcanized rubber of the rubber composition according to Comparative Example 1.

What is claimed is:

1. A rubber composition for bladder containing a rubber component containing butyl rubber, a fluorine-based polymer, and a citraconimide compound, wherein
when a total amount of the rubber component containing butyl rubber is taken as 100 parts by mass, the fluorine-based polymer is contained in an amount of 0.1 to 2 parts by mass and the citraconimide compound is contained in an amount of 0.2 to 2 parts by mass.

2. The rubber composition for bladder according to claim 1, further containing 1 to 10 parts by mass of a sorbitan fatty acid ester.

3. The rubber composition for bladder according to claim 1, further containing 1 to 10 parts by mass of a vegetable oil.

4. The rubber composition for bladder according to claim 2, further containing 1 to 10 parts by mass of a vegetable oil.

5. A bladder for tire vulcanization obtained by subjecting the rubber composition for bladder according to claim 1 to vulcanization and molding.

6. The bladder for tire vulcanization obtained by subjecting the rubber composition for bladder according to claim 2 to vulcanization and molding.

7. The bladder for tire vulcanization obtained by subjecting the rubber composition for bladder according to claim 3 to vulcanization and molding.

8. The bladder for tire vulcanization obtained by subjecting the rubber composition for bladder according to claim 4 to vulcanization and molding.
